(19) United States
(12) Patent Application Publication
(10) Pub. No.: US 2007/0097131 A1
(43) Pub. Date: May 3, 2007

(54) Display and operation device

(75) Inventor: Takayuki Ishida, Osaka (JP)

Correspondence Address: SMITH, GAMBRELL & RUSSELL, 1850 M STREET, N.W., SUITE 800, WASHINGTON, DC, 20036, US

(73) Assignee: KYOCERA MITA CORPORATION

(21) Appl. No.: 11/265,112

(22) Filed: Nov. 3, 2005

(51) Int. Cl. G06T 1/00

(52) U.S. Cl. 345/501

(57) ABSTRACT

In an inventive display and operation device, unit data to be transferred at a time for data transmission from the main body (2) to the display and operation portion (3) differs in size from unit data to be transferred at a time for data transmission from the display and operation portion (3) to the main body (2). More specifically, the unit data for the data transmission from the main body (2) to the display and operation portion (3) has a size of, for example, 16 bytes, while the unit data for the data transmission from the display and operation portion (3) to the main body (2) has a size of, for example, 1 byte. Thus, the size of the unit data for the data transmission from the main body (2) to the display and operation portion (3) is set suitably for transmission of image data, and the size of the unit data for the data transmission from the display and operation portion (3) to the main body (2) is set suitably for transmission of a key input signal.

### BACKGROUND OF THE INVENTION

1. Field of the Invention

The present invention relates to a display and operation device which performs predetermined operations as well as a displaying operation.

2. Description of Related Art

Image forming apparatuses are known which include a main body and a display and operation portion connected to the main body in a communicable manner. The display and operation portion includes, for example, a liquid crystal display device provided with a touch panel. Image data to be displayed on the display and operation portion is transmitted from the main body to the display and operation portion, and a signal of a key input to the display and operation portion is transmitted from the display and operation portion to the main body.

Japanese Unexamined Patent Publication No. 2000-231473, for example, proposes an image forming apparatus of this type in which image data to be transmitted from the main body to the display and operation portion is transferred by unit data of a predetermined data size in order to reduce a load on the communication between the main body and the display and operation portion.

However, the data to be transmitted from the main body to the display and operation portion include image data to be displayed on the display and operation portion, so that the amount of the data is relatively great. On the other hand, the data to be transmitted from the display and operation portion to the main body include key input signals, so that the amount of the data is relatively small. Therefore, if the size of the unit data to be transferred at a time for the transmission of the image data is relatively great, the efficiency of the data transmission from the display and operation portion to the main body is reduced.

### SUMMARY OF THE INVENTION

In view of the foregoing, it is an object of the present invention to provide a display and operation device which ensures efficient data transmission between the main body and the display and operation portion.

A display and operation device according to the present invention comprises a main body and a display and operation portion which communicate with each other, wherein unit data to be transferred at a time for data transmission from the main body to the display and operation portion has a relatively great size and unit data to be transferred at a time for data transmission from the display and operation portion to the main body has a relatively small size.

According to the present invention, image data can be efficiently transmitted from the main body to the display and operation portion, and operation signal data can be efficiently transmitted from the display and operation portion to the main body.

### BRIEF DESCRIPTION OF THE DRAWINGS

FIG. 1 is a block diagram illustrating the electrical construction of an image forming apparatus as a display and operation device according to one embodiment of the present invention;

FIG. 2 is a diagram illustrating the contents of an image data piece to be transferred from a VRAM to a communication portion via a bus in a main body;

FIG. 3 is a diagram illustrating how the image data piece transferred from the VRAM of the main body is expanded in a frame memory of a display and operation portion; and

FIG. 4 is a diagram illustrating how an image is displayed on an LCD on the basis of the image data expanded in the frame memory of the display and operation portion.

### DETAILED DESCRIPTION OF PREFERRED EMBODIMENTS

An embodiment of the present invention will hereinafter be described specifically with reference to the attached drawings.

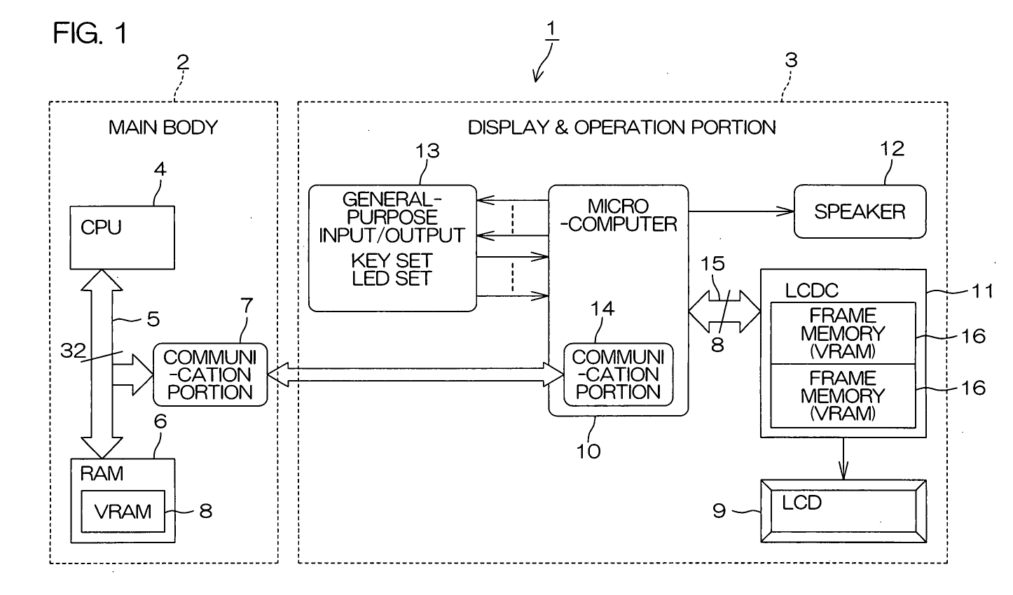

FIG. 1 is a block diagram illustrating the electrical construction of an image forming apparatus 1 as a display and operation device according to one embodiment of the present invention.

Referring to FIG. 1, the image forming apparatus 1, which may be a copying machine, a printer or a facsimile machine, for example, includes a main body 2 which performs an image forming operation on a sheet, and a display and operation portion 3 electrically connected to the main body 2.

The main body 2 includes a CPU 4 for controlling the operation of the image forming apparatus 1, and a RAM 6 and a communication portion 7 connected to the CPU 4 via buses 5 each having a predetermined bus width (e.g., 32 bits (4 bytes)) The RAM 6 includes a VRAM (video RAM) 8.

The display and operation portion 3 includes a liquid crystal display device (LCD) 9 provided with a touch panel. The LCD 9 performs a predetermined displaying operation. Further, keys displayed on the LCD 9 are operated to perform predetermined operations. The display and operation portion 3 includes a microcomputer 10, an LCDC (LCD controller device) 11 connected to the microcomputer 10 and the LCD 9, a speaker 12 and a general-purpose input/output portion 13 in addition to the LCD 9.

The microcomputer 10 includes a communication portion 14. The LCDC 11 is connected to the microcomputer 10 via a bus 15 having a predetermined bus width (e.g., 8 bits (1 byte), and the LCD 9 is connected to the microcomputer 10 via the LCDC 11 and the bus 15. The LCDC 11 includes a plurality of frame memories 16 (e.g., two frame memories) of VRAMS. The general-purpose input/output portion 13 includes a key set including a plurality of keys and a LED set including a plurality of light emitting diodes (LEDs).

The communication portion 7 of the main body 2 is connected to the communication portion 14 of the display and operation portion 3 in a serially communicable manner.

When a key displayed on the LCD 9 of the display and operation portion 3 is operated in the image forming apparatus 1, a signal for the key is inputted into the microcomputer 10 via the LCDC 11 and the bus 15. Upon reception of the signal, the microcomputer 10 converts the signal into a command, and data of the command is transmitted from the communication portion 14 to the communication portion 7 of the main body 2 by unit data of a predetermined data size (e.g., 1 byte).

Upon reception of the command from the display and operation portion 3, the CPU 4 of the main body 2 interprets the received command, and performs a control operation specified by the command. Where the display of the LCD 9 is to be changed, the CPU 4 generates image data to be displayed on the LCD 9 in the VRAM 8 provided in the RAM 6.

After communication commands (e.g., headers, addresses, checksums and the like) to be described later are appended to the image data generated in the VRAM 8 of the RAM 6, the image data is transferred to the communication portion 7 by unit data having a size (e.g., 16 bytes) which is greater than the unit data size (e.g., 1 byte) for the data transmission from the display and operation portion 3 to the main body 2, and transmitted from the communication portion 7 to the communication portion 14 of the display and operation portion 3. At this time, the image data generated in the VRAM 8 of the RAM 6 is transferred in the form of image data pieces each having a predetermined bus width (e.g., 32 bits (4 bytes)×plural stages (e.g., 4 stages)) to the communication portion 7 via the bus 5. Thus, the image data can be efficiently transferred by utilizing the entire bus width of the bus 5.

Upon reception of each of the image data pieces from the main body 2, the microcomputer 10 of the display and operation portion 3 interprets the command appended to the received image data piece, and expands the image data piece in one of the frame memories 16 provided in the LCDC 11. Then, the microcomputer 10 checks the image data piece for detection of an error on the basis of the interpreted command. If no error is detected in the image data piece, the image data piece expanded in the frame memory 16 is transferred to the LCD 9, and an image is displayed on the LCD 9 on the basis of the image data piece.

At this time, a signal indicating that the image data has been normally received may be transmitted from the display and operation portion 3 to the main body 2.

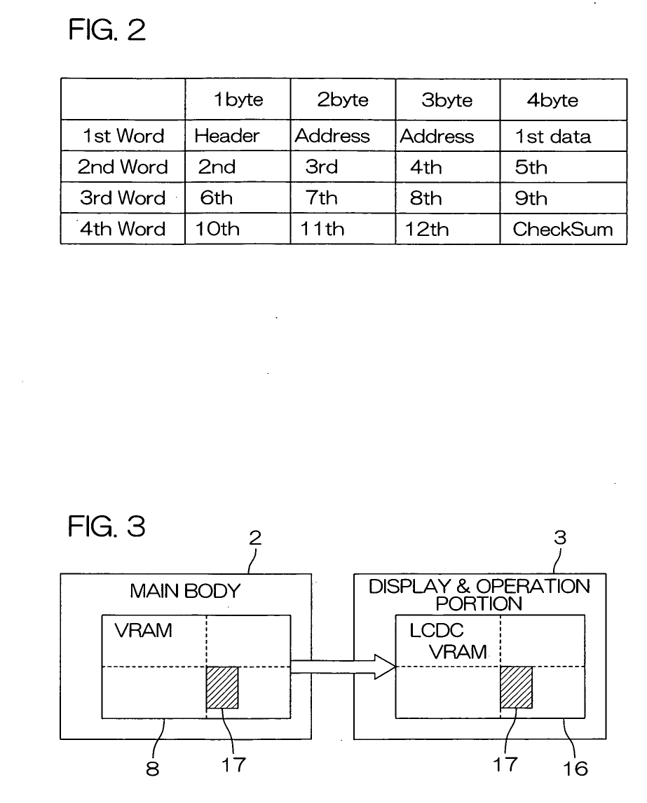

FIG. 2 is a diagram illustrating the contents of the image data piece to be transferred from the VRAM 8 to the communication portion 7 via the bus 5 in the main body 2.

Referring to FIG. 2, the image data is transferred in the form of data pieces each having 32 bits (4 bytes)×4 stages from the VRAM 8 to the communication portion 7 via the bus 5 in the main body 2.

A header indicating that a data piece of interest is an image data piece is assigned to the first byte of the first stage (1st Word). Data indicating the address of the image data piece in the entire image data to be transmitted from the main body 2 to the display and operation portion 3 is assigned to the second and third bytes of the first stage (1st Word). The contents of the image data piece are assigned to 12 bytes including the fourth byte of the first stage (1st Word), the first to fourth bytes of the second stage (2nd Word), the first byte to the fourth byte of the third stage (3rd Word) and the first to the third bytes of the fourth stage (4th Word) A checksum necessary for error check to check if the display and operation portion 3 has normally received the image data piece is assigned to the fourth byte of the fourth stage (4th Word).

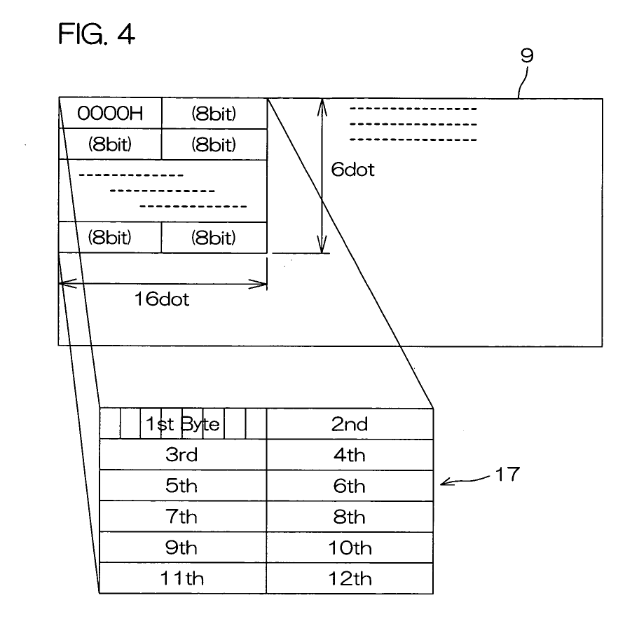

FIG. 3 is a diagram illustrating how the image data piece 17 transmitted from the VRAM 8 of the main body 2 is expanded in the frame memory 16 of the display and operation portion 3. FIG. 4 is a diagram illustrating how an image is displayed on the LCD 9 on the basis of the image data piece 17 expanded in the frame memory 16 of the display and operation portion 3.

Referring to FIGS. 3 and 4, the image data piece 17 (16 bytes) transferred from the main body 2 to the display and operation portion 3 at a time is a part of the image data to be transmitted from the main body 2 to the display and operation portion 3. The image data piece 17 is 12-byte image data of 6 lines×2 columns (6 pixels×16 pixels), and has a predetermined address. Thus, the image data piece is transferred from the main body 2 to the display and operation portion 3 in the form of a block including plural lines×plural columns.

The image data piece 17 transferred from the main body 2 to the display and operation portion 3 at a time is expanded at a position of the frame memory 16 of the display and operation portion 3 specified by the address data transmitted together with the image data piece 17.

Thus, the transmission of the entire image data from the main body 2 to the display and operation portion 3 is achieved by repeating the image data transfer once to plural times, and the entire image data is expanded in the frame memory 16 of the display and operation portion 3. Then, the image is displayed on the LCD 9 on the basis of the image data.

In this embodiment, the unit data to be transferred at a time for the data transmission from the main body 2 to the display and operation portion 3 differs in size from the unit data to be transferred at a time for the data transmission from the display and operation portion 3 to the main body 2. That is, the size of the unit data for the data transmission from the main body 2 to the display and operation portion 3 is set suitably for the transmission of image data and the like (e.g., 16 bytes), and the size of the unit data for the data transmission from the display and operation portion 3 to the main body 2 is set suitably for the transmission of key input signals and the like (e.g., 1 byte). Thus, the data transmission between the main body 2 and the display and operation portion 3 can be efficiently achieved.

The CPU 4 is interrupted every time the unit data is transferred from the main body 2 to the display and operation portion 3. The interruption also permits the data transmission from the display and operation portion 3 to the main body 2. Since the unit data for the data transmission from the main body 2 to the display and operation portion 3 (e.g., 16 bytes) is greater in size than the unit data for the data transmission from the display and operation portion 3 to the main body 2 (e.g., 1 byte), the number of interruptions is reduced to reduce the load on the CPU 4.

In this embodiment, where the size of the unit data for the data transmission from the main body 2 to the display and operation portion 3 is 16 bytes, the number of interruptions of the CPU 4 is reduced to one twelfth as compared with a case in which the size of the unit data is 1 byte. Thus, the load on the CPU 4 is significantly reduced.

Where the image data is transmitted on a block-by-block basis (plural lines×plural columns) from the main body 2 to the display and operation portion 3, the possibility that a character or the like to be displayed on the display and operation portion 3 (LCD 9) is contained in a block is increased as compared with a case where the image data is transmitted on a line-by-line basis. That is, where only a character displayed at a predetermined position of the display and operation portion 3 (LCD 9) is changed, it is merely necessary to transmit an image data block corresponding to the predetermined position. Therefore, the number of times of data transfer can be reduced as compared with the case where the image data is transmitted on a line-by-line basis. Thus, the data transmission between the main body 2 and the display and operation portion 3 can be efficiently achieved.

The present invention is not limited to the embodiment described above, but various modifications may be made within the scope of the present invention defined by the appended claims.

For example, the data to be transmitted from the main body 2 to the display and operation portion 3 is not limited to the image data, but may be data (e.g., about 6 bytes) of a lighting pattern for the LED provided in the general-purpose input/output portion 13, or data (e.g., about 20 bytes) of a sounding pattern for the speaker 12. In this case, it is merely necessary to change the header data to be appended to the data to be transmitted from the main body 2 to the display and operation portion 3. Thus, various data can be efficiently transmitted.

In this embodiment, the image forming apparatus 1 has been described as an example of the display and operation device, but the present invention is applicable not only to the image forming apparatus 1 but also to any other electrical appliances which can perform predetermined operations as well as a displaying operation.

What is claimed is:

1. A display and operation device comprising:
a main body; and
a display and operation portion connected to the main body in a communicable manner,
wherein unit data to be transferred at a time for data transmission from the main body to the display and operation portion differs in size from unit data to be transferred at a time for data transmission from the display and operation portion to the main body.

2. A display and operation device as set forth in claim 1, wherein the unit data for the data transmission from the main body to the display and operation portion is greater in size than the unit data for the data transmission from the display and operation portion to the main body.

3. A display and operation device as set forth in claim 2, wherein the unit data for the data transmission from the main body to the display and operation portion includes predetermined data and a command associated with the predetermined data.

4. A display and operation device as set forth in claim 3, wherein data to be transmitted from the main body to the display and operation portion is transferred on a block-by-block basis.

5. A display and operation device as set forth in claim 4, wherein the data to be transmitted from the main body to the display and operation portion include image data to be displayed on the display and operation portion.
